(19) United States
(12) Patent Application Publication
(10) Pub. No.: US 2026/0018056 A1
(43) Pub. Date: Jan. 15, 2026

(54) INTELLIGENT PARKING ASSIST SERVICE

(71) Applicant: Monmouth University, West Long Branch, NJ (US)

(72) Inventors: Raman Lakshmanan, Long Branch, NJ (US); Amanda Stojanov, Brick, NJ (US); Gianna Piroso, Lincroft, NJ (US); Davian J. Albarran, Edison, NJ (US); Andrew J. McGovern, Philadelphia, PA (US)

(21) Appl. No.: 19/265,185

(22) Filed: Jul. 10, 2025

Related U.S. Application Data
(60) Provisional application No. 63/669,444, filed on Jul. 10, 2024.

(51) Int. Cl. G08G 1/14

(52) U.S. Cl. CPC G08G 1/143

(57) ABSTRACT

An intelligent parking assist system and method adapted to identify, track, predict, alert, manage, and enforce parking spots through the application of a user interface, by which parking lot occupancy, management, and/or enforcement information is displayed and managed upon the collection of parking lot occupancy data via a vehicle sensor unit allocated to each parking user into a cloud-based software system, wherein the cloud-based software system and processes the collection of parking lot occupancy data to identify the status of parking spots and predict occupancy rates of parking lots in geofenced areas.

This application claims priority to U.S. Provisional Patent Application No. 63/669,444 filed Jul. 10, 2024, entitled “INTELLIGENT PARKING ASSIST SERVICE,” which is hereby incorporated by reference herein.

The present invention relates to an intelligent parking assist system, more particularly, a method and system that tracks vehicle location within user-defined areas to provide real-time parking spot availability and recommendations to users, facilitate parking enforcement and payment, and manage parking lot use.

### BACKGROUND

The current state of the art provides drivers with applications, parking kiosks, and street signage to locate available and permissible parking spaces. The current state of the art also includes systems that require manual input of location data by users or require the use of motion-activated sensors and cameras from different angles within parking lots. However, the current state of the art does not provide a system that guides users to immediately available parking spots or recommend potentially available parking spots at a scheduled time upon the processing of parking occupancy data. In public parking lots or parking lots of colleges, universities, business centers, and the like, drivers hope to find readily available parking spots, but upon arrival, find that most, if not all, spots are taken, or sections of the intended parking lot are closed or unavailable without warning due to parking lot management decisions or events. Drivers waste valuable time and resources as they search for available parking spots and risk being late for classes, meetings, and appointments. Additionally, parking lot administrators lack a convenient integrated platform to manage their parking lots, alert or notify users of any changes in parking availability, and enforce parking lot rules and regulations. To do the aforementioned, parking lot administrators must find a means to contact each individual owner or operator of the vehicles utilizing the parking spots, or to physically install signage or other indicators that parking lot users may only take notice of upon arrival. If violations regarding the use of the parking spots occur, patrol officers must keep track of the make and model of each parked vehicle, and the duration of which each vehicle is parked during their patrol to determine if the vehicle exceeded the acceptable time limit of the occupied parking spots.

### SUMMARY OF THE INVENTION

The present invention provides a parking system that enables a parking system user to efficiently locate and plan the use of empty parking spots and reduce the amount of time needed to find a parking spot. The parking system shows users parking lot capacity and directs users to parking spots that are available for immediate use via the collection and processing of data generated from the parking system components.

The present invention provides a parking system, the system comprising: a cloud-based software system adapted to process and manage user data and GPS location data; a parking user interface adapted to show parking users information relating to parking occupancy and allow the parking users to modify and input personal, vehicular, and optionally payment information, wherein the parking user interface is any suitable device, software, interactive modality or other mechanism adapted to display and exchange the user data and the GPS location data with the cloud-based software system; a vehicle sensor unit adapted to receive and transmit the GPS location data; a GPS correction system; and an administrative user interface, wherein the administrative user interface is adapted to show administrative users information relating to parking occupancy.

The present invention also provides, in another embodiment, a parking system wherein a cloud-based software system is adapted to predict parking lot occupancy and recommend specific parking spots to the parking users based on accumulated historical occupancy data.

The present invention also provides, in another embodiment, a parking system wherein a vehicle sensor unit is comprised of a central processing unit; a memory; a GPS module, wherein the GPS module gathers a geolocation of the vehicle sensor unit; a Bluetooth module, wherein the Bluetooth module facilitates an exchange of data between the vehicle sensor unit and the parking user interface; and a battery.

The present invention also provides, in another embodiment, a parking system wherein a GPS station is comprised of a station memory; multiple satellites; a station GPS module, wherein the station GPS module gathers fixed location data from multiple satellites via the GPS antenna; a GPS antenna distribution unit; a station central processing unit adapted to receive location data from the GPS receiver unit, compute differential corrections to the location data, and stream corrected location data to the cloud-based software system; a station power unit, wherein the station power unit manages power to the GPS station and the GPS antenna; a GPS antenna; and a network interface that streams correction data from the cloud-based software system via an ethernet module.

The present invention also provides, in another embodiment, a parking system wherein the administrative user interface is adapted to show the administrative users information relating to parking occupancy and management, and wherein the administrative user interface allows the administrative users to modify the parking occupancy information and circulate parking-related announcements to the parking user interface.

The present invention also provides, in another embodiment, a parking system further comprising a parking spot marker user interface, wherein the parking spot marker user interface is adapted to allow the administrative users to add, remove, or otherwise modify the status of every parking spot of the parking management system.

The present invention also provides, in another embodiment, a parking system further comprising a patrol user interface, wherein the patrol user interface is adapted to show patrol users information relating to parking occupancy, management, payment, and enforcement and allow the patrol users to modify parking occupancy information, circulate parking-related announcements to the users, and issue electronic violation citations to the users.

The present invention also provides, in another embodiment, a parking system wherein the patrol user interface further comprising a vehicle image detection model.

The present invention also provides, in another embodiment, a method for managing parking lots, the method comprising the following steps: establishing a geofence of at least one parking lot; gathering fixed GPS location data of the at least one parking lot and at least one parking spot; acquiring live GPS location data of a vehicle sensor unit within the geofence of the at least one parking lot; correcting the live GPS location data of the vehicle sensor unit to obtain adjusted GPS location data; recording the adjusted GPS location data; and establishing a geofence around the vehicle sensor unit; displaying occupancy data of the at least one parking lot on at least one user interface.

The present invention also provides, in another embodiment, a method for managing parking lots, wherein fixed GPS location data of the at least one parking lot and the at least one parking spot are stored in a cloud-based software system.

The present invention also provides, in another embodiment, a method for managing parking lots, wherein a cloud-based software system is adapted to predict parking lot occupancy and recommend specific parking spots to parking users based on accumulated historical occupancy data.

The present invention also provides, in another embodiment, a method for managing parking lots, wherein the vehicle sensor unit is a hardware device comprising: a central processing unit; a memory; a GPS module, wherein the GPS module gathers a geolocation of the vehicle sensor unit; a Bluetooth module, wherein the device Bluetooth module facilitates an exchange of data between the vehicle sensor unit and the parking user interface; and a battery.

The present invention also provides, in another embodiment, a method for managing parking lots, wherein the fixed GPS location data is acquired by a GPS correction system, the GPS correction system comprising: a station memory; a GPS antenna; multiple satellites; a station GPS module, wherein the station GPS module gathers fixed location data from the multiple satellites via the GPS antenna; a GPS antenna distribution unit; a station central processing unit adapted to receive location data from the GPS receiver unit, compute differential corrections to the location data, and stream corrected location data to the cloud-based software system; a power unit; wherein the power unit manages power to the GPS station and the GPS antenna; and a network interface that streams correction data from the cloud-based software system via an ethernet module.

The present invention also provides, in another embodiment, a method for managing parking lots, wherein adjusted GPS location data is processed by and recorded in a cloud-based software system adapted to process and manage user data and the GPS location data.

The present invention also provides, in another embodiment, a method for managing parking lots, wherein the at least one user interface includes: a parking user interface, wherein the parking user interface is adapted to show the parking users information relating to parking occupancy and allow the parking users to modify and input personal, vehicular, and optionally payment information, wherein the parking user interface is any suitable device, software, interactive modality or other mechanism adapted to display and exchange the user data and the GPS location data with the cloud-based software system; and an administrative user interface, the administrative user interface is adapted to show administrative users information relating to parking occupancy.

The present invention also provides, in another embodiment, a method for managing parking lots, wherein administrative users manage information relating to the parking occupancy by allowing the administrative users to modify the parking occupancy information and circulate parking-related announcements to the parking user interface.

The present invention also provides, in another embodiment, a method for managing parking lots, wherein at least one user interface also includes a patrol user interface, wherein the patrol user interface is adapted to allow patrol users to patrol parking lots, issue digital parking violation citations, and view and manage information relating to parking occupancy and safety via the patrol user interface, and wherein the parking patrol user interface is adapted to allow the patrol users to modify the parking occupancy information and circulate parking-related announcements to the parking user interface.

The present invention also provides, in another embodiment, a method for managing parking lots, wherein at least one user interface also includes a parking spot marker user interface, wherein the parking spot marker user interface is adapted to allow the administrative users to add, remove, or otherwise modify the status of every parking spot of the parking management system.

### DESCRIPTION OF THE DRAWINGS

Further objects, features, and advantages of the invention will become apparent from the following detailed description taken in conjunction with the accompanying figures showing illustrative embodiments of the invention, in which:

FIG. 1 shows an exemplary embodiment of components included in the parking system;

FIG. 2 shows an exemplary embodiment of components included in the parking system's cloud-based software system;

FIG. 3 shows an exemplary embodiment of the vehicle sensor unit;

FIG. 4 shows an exemplary embodiment of the parking system's GPS correction system;

FIG. 5A shows an exemplary embodiment of the parking system's mobile application components and connections;

FIG. 5B shows an exemplary embodiment of the parking system's mobile application user interface home screen;

FIG. 5C shows an exemplary embodiment of the parking system's mobile application user interface lot screen;

FIG. 5D shows an exemplary embodiment of the parking system's mobile application user interface alert screen;

FIG. 6A shows an exemplary embodiment of the parking system's patrol application components and connections;

FIG. 6B shows an exemplary embodiment of the parking system's patrol application user interface spot radius map screen;

FIG. 6C shows an exemplary embodiment of the parking system's patrol application user interface ticket screen;

FIG. 7A shows an exemplary embodiment of the parking system's administrator portal components and connections;

FIG. 7B shows an exemplary embodiment of the parking system's administrator portal spot selection screen;

FIG. 8 shows an exemplary embodiment of the parking system's parking spot marker application components and connections;

FIG. 9A shows a flow chart showing communications between the vehicle sensor, parking system's mobile application, and parking system's cloud-based software system; and

FIG. 9B shows a flow chart showing communications between the parking system's cloud-based software system and the parking system's GPS correction system.

### DETAILED DESCRIPTION

The present invention provides a system and method for collecting parking lot occupancy data, disseminating parking lot occupancy data to system users, and digitally managing and enforcing parking lot rules and regulations. The parking system is an intelligent parking assistance service comprised of hardware and software components to guide drivers to available parking spots on university campus, corporate campus, and shopping center lots, event parking lots, street level parking in towns and cities, and the like. In addition to guiding drivers to available spots, the service also assists parking administration and parking enforcement to manage and monitor parking lot occupancy and vehicle activity.

The present invention allows drivers to view, via their user interfaces (e.g., a mobile or web application), parking spots that are immediately available, as well as parking spot recommendations and occupancy predictions, subject to user-specific information that is manually or automatically entered.

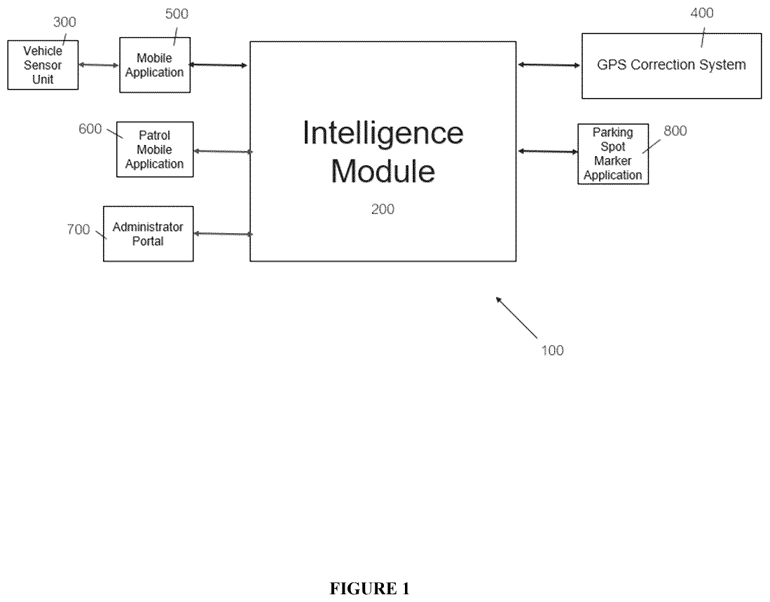

FIG. 1 shows an exemplary embodiment of the components included in the parking system 100. Parking system 100 includes intelligence module 200, vehicle sensor unit 300, GPS correction system 400 (comprised of GPS station 450, GPS antenna 460, and GPS satellites 470), mobile application 500, patrol mobile application 600 and/or administrator portal 700, and parking spot marker application 800.

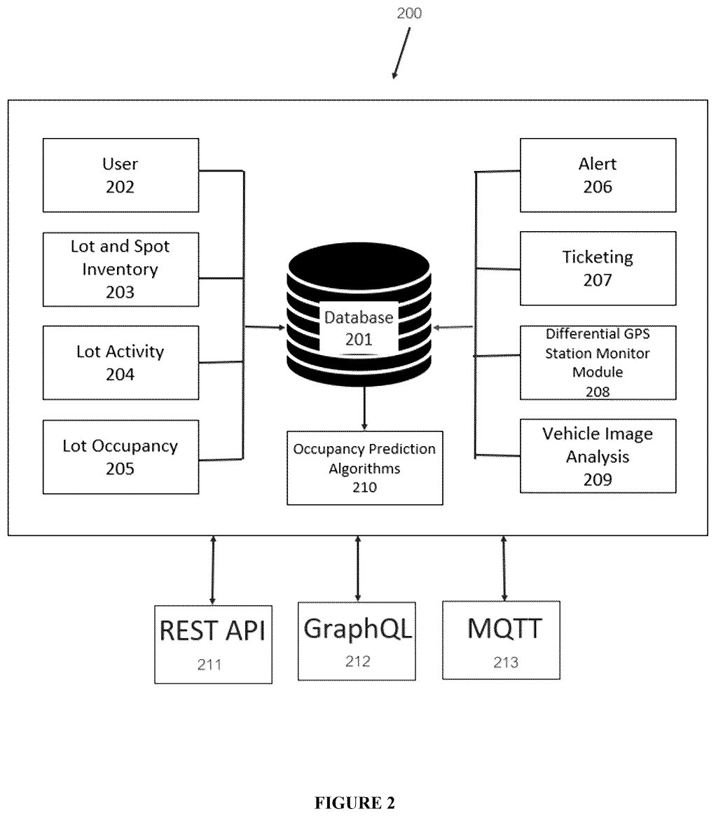

FIG. 2 depicts an exemplary embodiment of intelligence module 200. Intelligence module 200 is a cloud-based software system that includes a set of application programming interfaces (“APIs”), software algorithms to process data reported by all components interfacing with parking system 100, and a differential GPS station monitoring module for the accurate reporting of vehicle location to the nearest two centimeters. Intelligence module 200 collects location data of vehicles equipped with vehicle sensor units 300 as they travel in the system-geofenced parking lots, analyzes the location data, and communicate occupancy and vacancy of parking spots to parking system users via user interfaces (i.e., mobile application 500, patrol mobile application 600, and administrator portal 700). Information pertaining to occupancy and vacancy of parking spots is pushed to (a) all mobile application 500 users to locate available spots in parking lots, and (b) all patrol mobile application 600 users and administrator portal 700 users to manage and enforce parking operations and policies.

More specifically, intelligence module 200 includes database 201, which is a regional database that stores all parking system 100 related data, including, but not limited to: parking user information (e.g., personal information, vehicle information, travel schedules to campus, parking preferences) 202; lot and spot inventory information (e.g., geospatial data of parking lots and spots and related attributes, including whether the lots or spots are open, closed, reserved, or limited for use by handicapped persons) 203; lot activity information (e.g., real-time tracking of parking lots and spots vehicle activity) 204, including algorithms to detect vehicles entering and leaving parking spots, and spot use duration; lot occupancy information 205; differential GPS station monitor module 208 that handles differential correction data from the GPS correction system 400 and applies the differential correction data to all incoming GPS location data from vehicle sensor units 300; and occupancy prediction algorithms 210 that instruct the processing of historical data of parking lot occupancy based on the day of the week and time of the week.

Database 201 also includes alert information (i.e., system-wide or directly to parking users of specific lots) 206 that can be scheduled or immediately released by parking administrators; ticketing information 207 relating to parking violation-related digital ticketing (e.g., captured vehicle images and violation code) and algorithms to process data regarding parking violations associated with a parked vehicle; vehicle image analysis module 209 to analyze images uploaded into database 201 to detect license plate and state and number information, and vehicle make, model and color from images to assist with digital ticketing by patrol officers.

Intelligence module 200 exchanges data with a Representational State Transfer API (“REST API”) 211 and GraphQL API 212 to enable the components of parking system 100 to communicate with each other in a structured way. Intelligence module 200 utilizes Message Queuing Telemetry Transport (“MQTT”) 213 as a message queue service for the remote devices utilized in parking system 100, including the vehicle sensor unit 300 and GPS station 450, to push data to and from intelligence module 200 and associated mobile applications/portals (i.e., mobile application 500, patrol mobile application 600, administrator portal 700, and parking spot marker application 800). However, the invention is not so limited, and other APIs and message queue services of comparable function and capabilities may also be utilized.

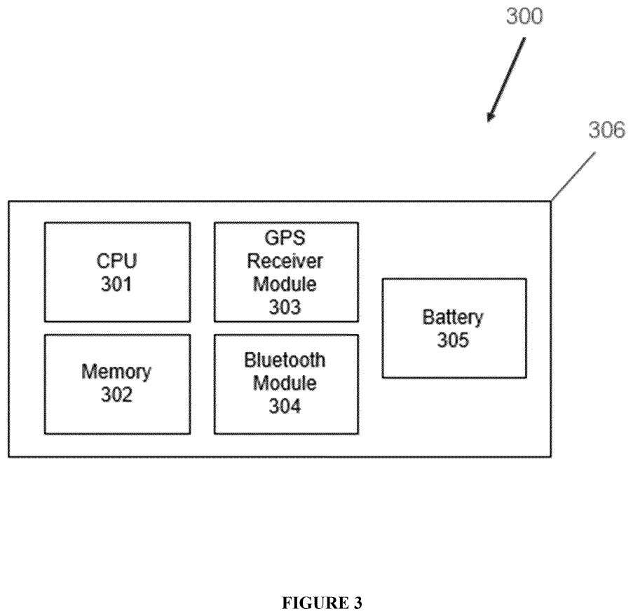

FIG. 3 depicts an exemplary embodiment of vehicle sensor unit 300. Vehicle sensor unit 300 is a rechargeable or battery powered device with embedded software. Vehicle sensor unit 300 can be placed internal or external to the parking user's vehicle (e.g., on the dashboard or affixed the vehicle's windshield). Vehicle sensor unit 300 includes a central processing unit (“CPU”) 301, unit memory 302, GPS receiver module 303, Bluetooth module 304, and battery 305, and housing 306. Housing 306 holds vehicle sensor unit 300 components (i.e., CPU 301, unit memory 302, GPS receiver module 303, Bluetooth module 304, and battery 305) and could be of any shape and material (i.e., plastic) and can be modified so that housing 306 is sealed to prevent tampering of its internal components, or modified so that only administrative users can open housing 306 to fix or modify the vehicle sensor unit 300 (i.e., fix or replace internal components).

CPU 301 is a low-power consumption central processing device that manages all interaction with and among other components of vehicle sensor unit 300. Unit memory 302 is a memory that retains application and location data even when the vehicle sensor unit 300 is turned off or powered down (e.g., an erasable programmable read-only memory (“EPROM”)). Unit memory 302 stores the computer operating system data and embedded applications of the vehicle sensor unit 300. GPS receiver module 303 gathers and processes the geolocation data of the vehicle sensor unit 300. Bluetooth module 304 facilitates the exchange of location data and instructions between vehicle sensor unit 300 and mobile application 500, even when the vehicle sensor unit 300 is powered down (i.e., via Bluetooth low energy). Battery 305 is a rechargeable or non-rechargeable battery unit that manages the power usage of vehicle sensor unit 300.

In another embodiment, vehicle sensor unit 300 is adapted to emit a visual signal (i.e., a flashing light) if a parking user attempts to park in a parking spot that is marked closed or otherwise unavailable.

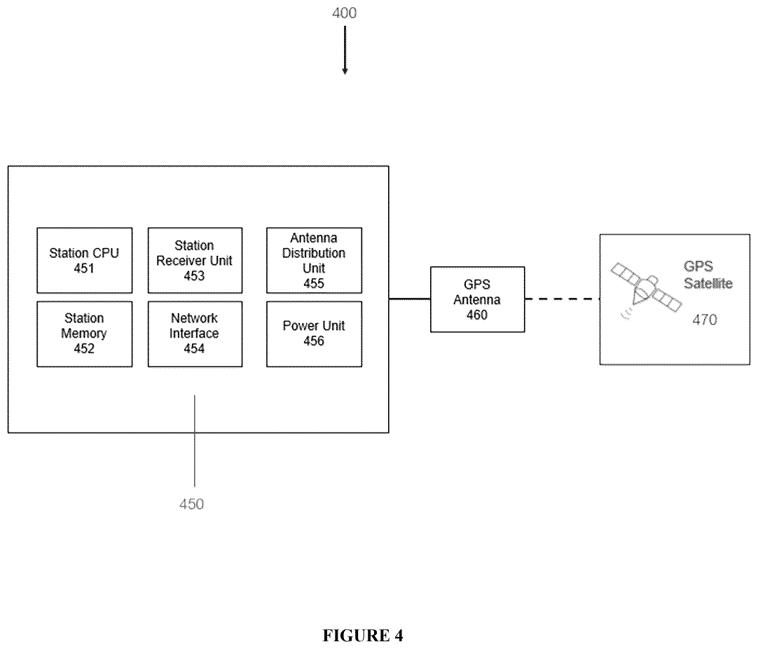

FIG. 4 shows an exemplary embodiment of GPS correction system 400, which is comprised of GPS station 450, GPS antenna 460, and GPS satellites 470. The GPS correction system 400 provides differential GPS location correction data to apply to reported GPS location data from vehicle sensor unit 300 and transmits the corrected data to intelligence module 200. This enables accurate determination of whether a vehicle equipped with a vehicle sensor unit 300 occupies a parking spot within the geofenced areas of parking system 100. Because parking spots are typically two meters apart, the determination of whether a vehicle equipped with a vehicle sensor unit 300 requires an accuracy of location determination to be a meter or less. Typically, GPS positional data acquisition is susceptible to interference from inclement weather conditions (e.g., clouds, lightning, thunderstorms, and solar flares). With the application of differential GPS location correction data, GPS correction system 400 improves the accuracy of location data from 5-10 meters down to approximately 2 centimeters, thereby providing an improved system for accurately acquiring location data of parked vehicles.

GPS station 450 includes station CPU 451, station memory 452, station receiver unit 453, network interface 454, station antenna distribution unit 455, and power unit 456. Station CPU 451 is a computing unit that coordinates GPS station 450 activities for the purposes of gathering live location data from station receiver unit 453, computing the differential GPS location correction using known fixed location data from GPS antenna 460 and live location data from vehicle sensor unit 300, and streaming the correction to the differential GPS station monitor 208 of intelligence module 200. Station memory 452 stores the collection of GPS correction data and correction computations, and streams as many as five samples per second to intelligence module 200. Station receiver unit 453 is a precise GPS module that gathers positional data from as many as 24 satellites. Station receiver unit 453 is adapted to receive as many as five location data samples per second. Station CPU 451 computes the location data correction using location data from vehicle sensor units 300 and known fixed location data from GPS antenna 460. Network interface 454 is an ethernet module that streams correction data at a high speed via internet connection. Station antenna distribution unit 455 is a hardware unit that powers GPS antenna 460 and distributes the acquired location data to all locally connected vehicle sensor units 300 of parking system 100 for calibration and testing during maintenance via intelligence module 200. Power unit 456 is a power unit that manages the power of the entire GPS station 450 and GPS antenna 460. GPS antenna 460 is a fixed position GPS antenna mounted on top of the highest altitude in the area where the parking system 100 will operate. The GPS antenna 460 is connected to GPS station 450 via wired connection (e.g., a coaxial cable) and receives GPS location data of calibrated fixed positions from GPS satellites 470.

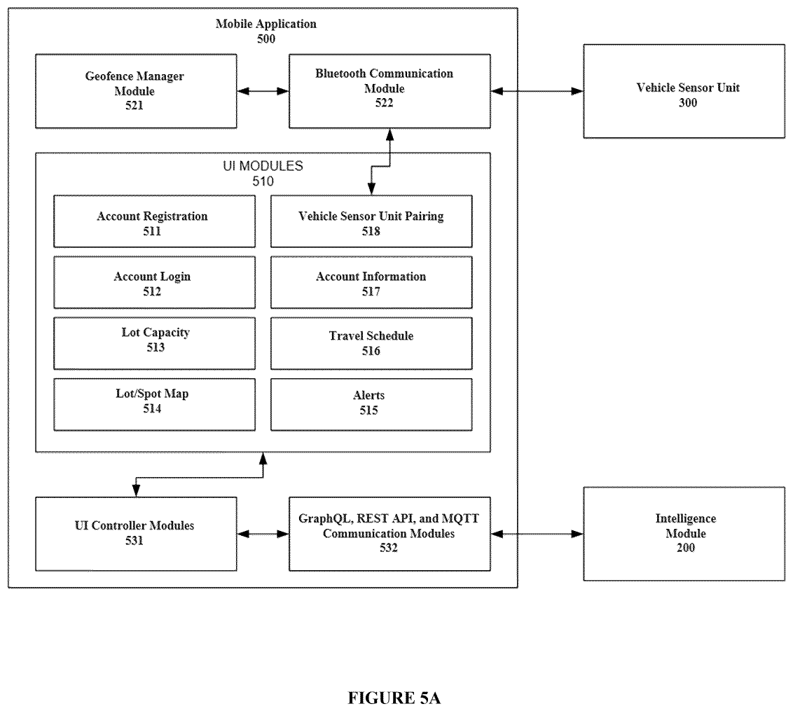

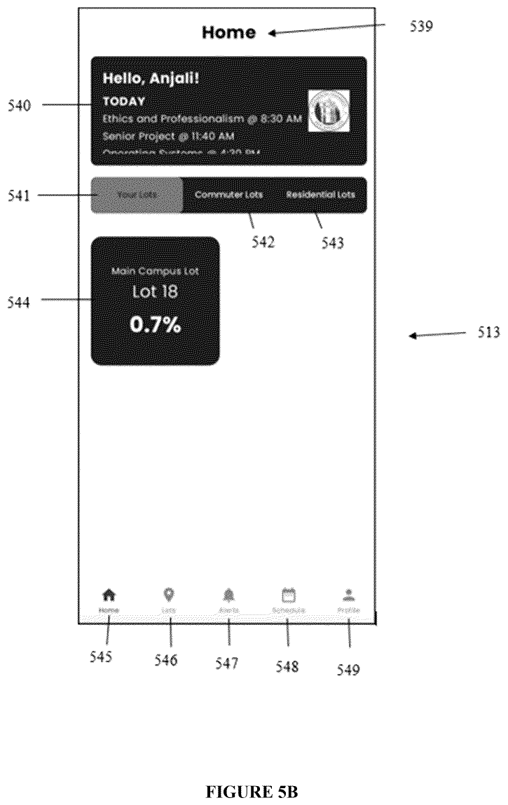

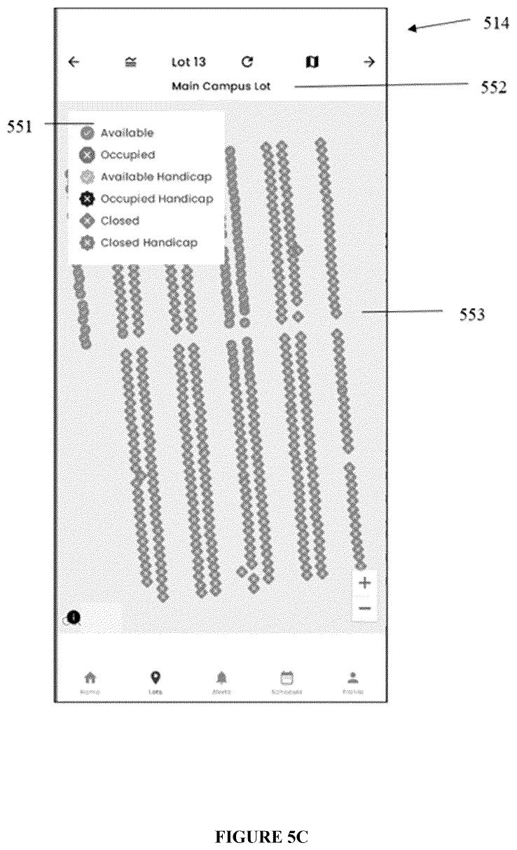

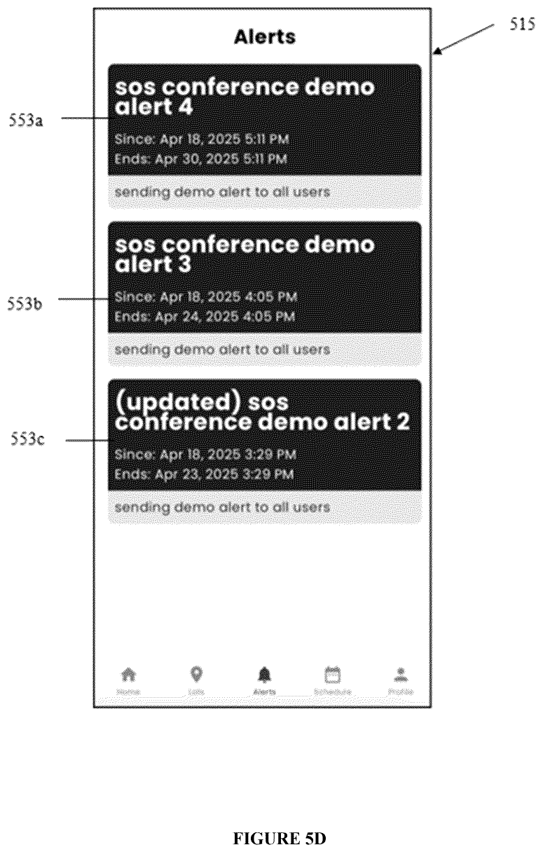

FIG. 5A depicts an exemplary embodiment of the mobile application 500 components and connections. Mobile application 500 is a front-end UI service that parking users interact with on their smartphone devices. Mobile application 500 securely communicates location data and instructions between vehicle sensor unit 300 and intelligence module 200 so that the parking user can view parking lot and spot occupancy information. If a parking user attempts to park in a closed or otherwise unavailable parking spot, mobile application 500 is adapted to instruct emit an auditory signal and a message alert to the parking user to indicate that parking patrol will be notified of the parking user's unauthorized occupation of the parking spot. Location data includes those pertaining to the parking user's vehicle's GPS coordinates, which are processed by the GPS receiver module 303 when the vehicle sensor unit 300 is inside or outside a geofenced area (i.e., a virtually enclosed area containing a parking lot or a parking lot spot). Location data received by the mobile application 500 via Bluetooth module 304 is sent to intelligence module 200 for processing and analysis. Mobile application 500 may also instruct vehicle sensor unit 300, via notification from intelligence module 200, to alter its power state (i.e., power on or off when inside or outside a geofenced area, respectively). Mobile application 500 enables parking users to view alerts pertaining to parking system 100 and parking lots/spots, input parking user information (e.g., personal information, vehicle information, travel schedules to campus, parking preferences), receive advanced notifications on predicted parking lot occupancy at selected lots based on the parking lot's historical occupancy data, as well as manage and review parking violation citation information and payment. Upon the detection of the parking user's location data vehicle within the geofenced area, parking users may also opt to reserve or claim a vacant parking spot for a limited period of time. Additionally, mobile application 500 enables parking users to notify patrol users to check the parking spot if the parking users see a parking spot status that does not match their visual observations.

Mobile application 500 includes geofence manager module 521, Bluetooth communication module 522, user interface (“UI”) modules 510, UI controller modules 531, and GRAPHQL, REST API, and MQTT communication modules 532.

The Bluetooth communication module 522 is a background module of mobile application 500 that facilitates the sending and receiving of vehicle sensor unit 300 location data and instructions between the vehicle sensor unit 300 and mobile application 500.

Geofence manager module 521 is a background module that detects the vehicle sensor unit 300—equipped vehicle location in comparison to a geofenced area, upon the acquisition of location data transmitted from vehicle sensor unit 300 via Bluetooth communication module 522. Geofence manager module 521 automatically communicates with the vehicle sensor unit 300, via Bluetooth communication module 522, to power on when inside geofenced areas and to power off or enter into a lower-power state when outside of geofenced areas or within a parking spot.

UI modules 510 directs the mobile application 500 to display UI screens to parking users, which includes, but is not limited to, an account registration UI 511, account login UI 512, lot capacity UI 513, lot/spot map UI 514, alert UI 515, travel schedule UI 516, account information UI 517, and vehicle sensor unit pairing UI 218. Account registration UI 511 enables parking users to create their mobile application 500 account with their vehicle information and connect their account to an existing organizational email account. Account login UI 512 enables parking users to use an existing organizational email account to log into the mobile application 500. The lot capacity UI 513 displays the parking user's daily arrival schedule and a list of real-time occupancy percentages for any lot available to them that they wish to view the occupancy percentages for. The lot capacity UI 513 can also be organized to display specific lot occupancy percentages based on parking user preference of specific lots. Lot/spot map UI 514 displays a map view of a chosen parking lot with map annotations and legends to display the live status of parking spots (e.g., if the spot is available, occupied, closed, handicap available, handicap occupied) in conjunction with a depiction of the parking user's vehicle location. Alert UI 515 displays a list of parking-related and safety-related alerts sent out by the parking administration and/or patrol officers. Travel schedule UI 516 allows parking users to input and edit their expected arrival times upon a preferred or chosen lot for each day of the week. Account information UI 517 displays the parking user's basic account information, including the parking user's contact information, vehicle information, and information pertaining to the parking user's vehicle sensor unit 300. Vehicle sensor unit pairing UI 518 allows parking users to manually input or scan a code on their assigned vehicle sensor unit 300 in order to pair the vehicle sensor unit 300 to their smartphone device, thereby allowing for the exchange of data and instructions between the parking user, via the mobile application 500, and the vehicle sensor unit 300.

UI controller modules 531 are background modules that format and display data acquired by intelligence module 200 for viewing by parking users via mobile application 500. GraphQL, REST API, and MQTT communication modules 532 are background modules that interact with GraphQL 212, REST API 211, and MQTT 213, respectively, of intelligence module 200 for the sending and receiving of data.

FIG. 5B is an exemplary embodiment of lot capacity UI 513. Lot capacity UI 513 displays banner 540 on home screen 539, which shows the parking user's daily arrival schedule 540. Home screen 539 includes a summary view of the parking user's preferred lot(s) upon selection of the “Your Lots” call-to-action (“CTA”) button 541 so that the parking user may quickly view preferred lot occupancy data 544 (i.e., lot occupancy percentages). Home screen 539 may also include a summary view of all commuter parking lots and all residential parking lots via the “Commuter Lots” CTA button 542 and “Residential Lots” CTA button 543, so that parking users may quickly view occupancy data of all commuter and/or residential parking lots available to them. Parking users may access other application functions (e.g., lot/spot map UI 514, alert UI 515, travel schedule UI 516, and account information UI 517) via the “Lots” CTA button 546, “Alerts” CTA button 547, “Schedule” CTA button 548, and “Profile” CTA button 549. If a parking user is on any other display module, they may return to home screen 539 via the “Home” CTA button 545.

FIG. 5C is an exemplary embodiment of lot/spot map UI 514. Lot/spot map UI 514 displays the lot name 552 (e.g., “Main Campus Lot”) and a map 553 of the selected lot displaying the status of parking spots. Lot/spot map UI 514 also displays map legend 551, defining the types of statuses that may be associated with each parking spot (e.g., if the spot is available, occupied, closed, and whether the spot is associated with a handicap status). Although the exemplary embodiment of FIG. 5C shows the map display in a non-satellite format, a satellite format may also be selected and used by the parking user.

FIG. 5D is an exemplary embodiment of alert UI 515. Alert UI 515 displays alerts 533a-c, which may include alert-related information (e.g., an alert title, the effective start date and effective end date for the alert, and alert notes).

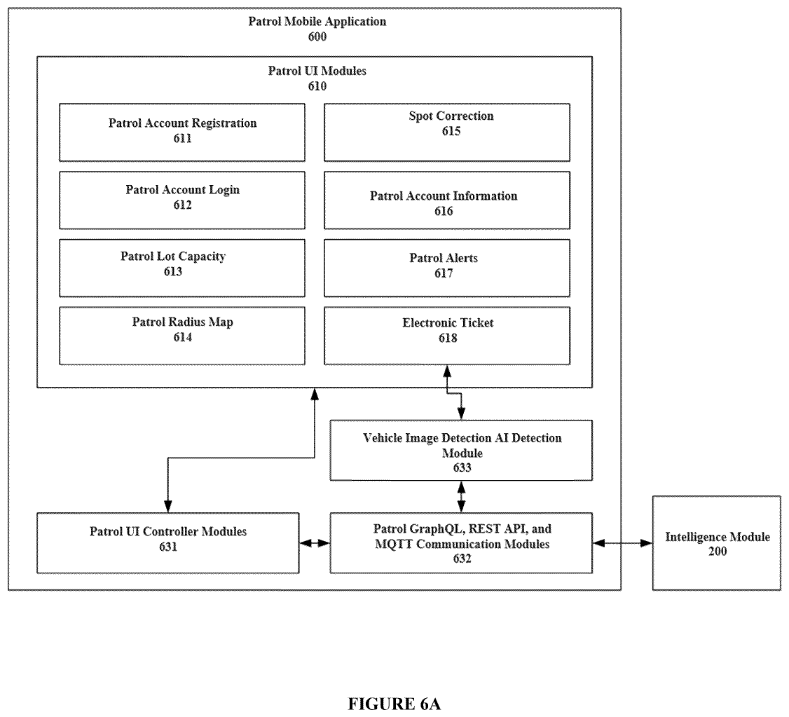

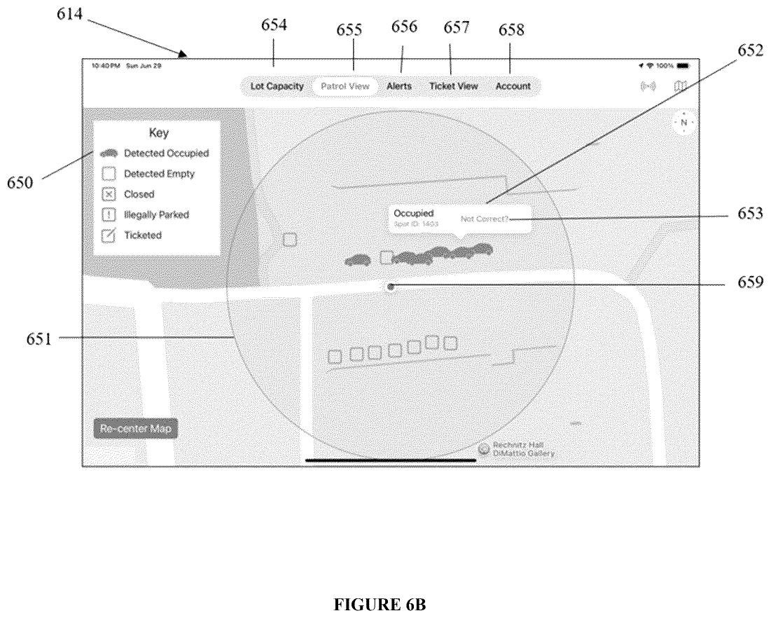

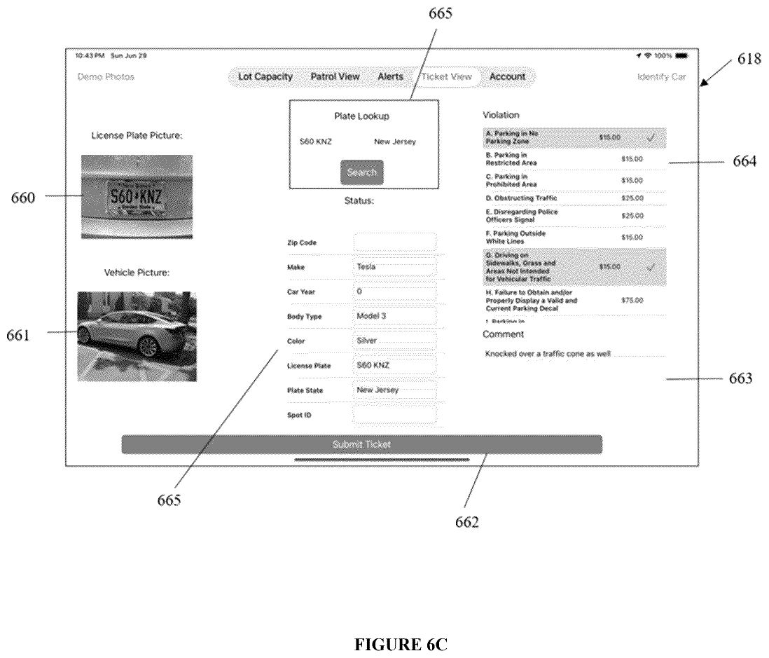

FIG. 6A is an exemplary embodiment of patrol mobile application 600. Patrol mobile application 600 is a front-end UI service that patrol users interact with on their mobile devices (e.g., a smartphone or tablet). Patrol mobile application 600 interacts with intelligence module 200 to format and display system data processed by intelligence module 200 as readable information on its UI displays. Patrol mobile application 600 also includes background modules that interacts with an artificial intelligence (“AI”) image analysis tool to analyze images and return vehicle-specific information to patrol users.

Patrol UI modules 610 direct patrol mobile application 600 to display UI screens to patrol users, which includes, but is not limited to patrol account registration UI 611, patrol account login UI 612, patrol lot capacity UI 613, patrol radius map UI 614, patrol spot correction UI 615, patrol account information UI 616, patrol alert UI 617, and patrol electronic ticket UI 618. Patrol account registration UI 611 allows patrol officers to create their own patrol user account with their patrol vehicle information and connects their account to an existing organization email account. Patrol account login UI 612 allows patrol officers to use their existing organizational email account to log into the patrol mobile application 600. Patrol lot capacity UI 613 displays a map view of the campus to be patrolled by the patrol officer, with annotations over each of the campus' parking lots. Each annotation displays the lot identifier and the corresponding occupancy percentage, which can be selected for a more detailed view of the status of parking spots reported in real time. Patrol radius map UI 614 displays a map view with annotations for each of the parking spots within a specific radius of the patrol officer's patrol vehicle, a radius specified by the patrol officer via the patrol radius map UI 614. The annotations may include customized symbols and colors to represent parking spots that are available, occupied, or closed, and to indicate whether a vehicle is occupying the spot illegally, or has already received a parking citation.

Patrol spot correction UI 615 allows patrol officers to update any incorrect information regarding a selected parking spot, with the option to issue a parking citation for a parking violation that caused the parking spot information to be incorrect. Patrol account information UI 616 displays the patrol officer's basic information related to their patrol user account, email, vehicle sensor unit 300, and vehicle. Patrol alert UI 617 displays a list of parking and safety-related alerts sent out by the patrol officer's organization administrators of patrol mobile application 600. Patrol electronic ticket UI 618 allows patrol officers to electronically generate tickets for illegally parked vehicles. Through patrol electronic ticket UI 618, a patrol officer can take a time-stamped and location-stamped photo of the vehicle and the license plate. These photos are sent to the Vehicle Image AI Detection Request (“VIAIDR”) module 633. The VIAIDR module 633 is a background module that interacts with the vehicle image analysis module 209 of intelligence module 200, via patrol GraphQL, REST API, and MQTT communication modules 632 to process and return vehicle information (i.e., license plate text, vehicle make, model, and color) obtained from time and location-stamped photos taken by the patrol officer via patrol electronic ticket UI 618. Once the vehicle information is received, patrol electronic ticket UI 618 auto-fills fields of the ticket with the generated vehicle information. The VIAIDR module 633 also searches database 201 for any parking user information that corresponds to the license plate, to be auto filled in the fields of the generated ticket via patrol electronic ticket UI 618. A patrol officer must designate a parking violation code and may add comments before submission into database 201.

Patrol UI controller module 631 is a background module that handles the format and display of data accumulated and processed by intelligence module 200 to be displayed by patrol UI modules 610. Patrol GraphQL, REST API, and MQTT communication modules 632 includes background modules that interact with the GraphQL 212, REST API 211, and MQTT 213 of intelligence module 200 for the sending and receiving of live data between intelligence module 200 and patrol mobile application 600.

FIG. 6B depicts an exemplary embodiment of patrol radius map UI 614. Patrol radius map UI 614 shows patrol officers a map of all parking spots within a specified radius 651 of their patrol vehicle 659 being driven, showing the patrol officer which parking spots are occupied, empty, or closed, and whether the occupant of the spot is illegally parked or was already issued a ticket for a parking violation via annotations on the map, as defined by patrol annotation key 650. Patrol officers may select a specific parking spot or parking spot occupant to view information box 652 for further information (i.e., spot status and spot identification information). If the information is incorrect in information box 652, the patrol officer can access the patrol spot correction UI 615 to make corrections via selection of the “Not Correct” CTA button 653. The patrol officer may also access patrol lot capacity UI 613 via the patrol “Lot Capacity” CTA button 654, return to patrol radius map UI 614 via and the “Patrol View” CTA button 655, access patrol account information UI 616 via the patrol “Account” CTA button 658, access the patrol alert UI 617 via the patrol “Alerts” CTA button 656, and access the patrol electronic ticket UI 618 via the patrol “Ticket View” CTA button 657.

FIG. 6C depicts an exemplary embodiment of patrol electronic ticket UI 618. Patrol electronic ticket UI 618 allows patrol officers to electronically generate tickets for vehicles in violation of parking lot rules and regulations. A patrol officer can take a time-stamped and location-stamped vehicle photo 661 and a license plate photo 660. The corresponding data of vehicle photo 661 and license plate photo 660 are sent to VIAIDR module 633, which interacts with the vehicle image analysis module 209 of intelligence module 200, via patrol GraphQL, REST API, and MQTT communication modules 632, to process and return text-based vehicle information (i.e., license plate text, vehicle make, model, and color). The text-based vehicle information is auto filled in information fields 665. The VIAIDR module 633 also searches database 201 for any other parking user information that corresponds to the vehicle, which may also be auto filled in information fields 665. A patrol officer designates a parking violation code at violation box 664 and may add comments in comment box 663 before submission into database 201 via the “Submit Ticket” CTA button 662.

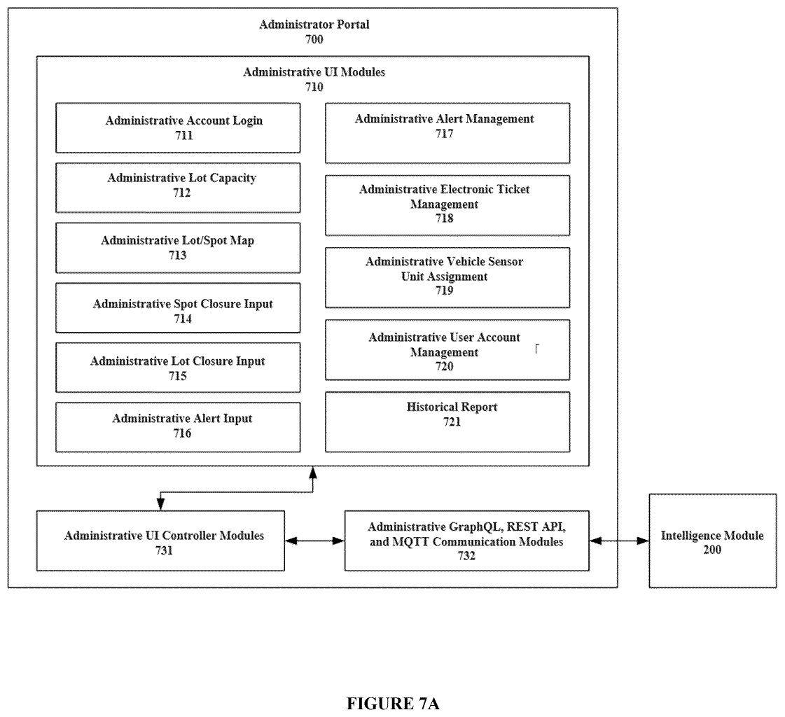

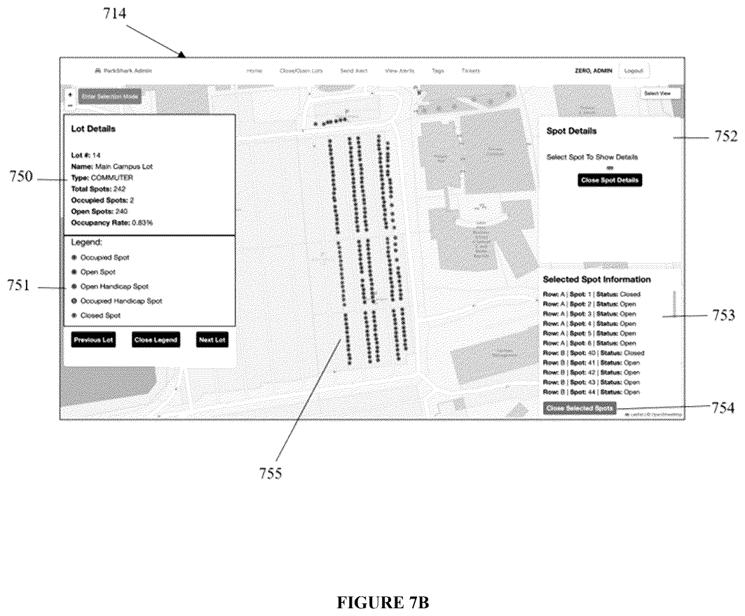

FIG. 7A shows an exemplary embodiment of administrator portal 700, which is the front-end UI service that parking lot administrators and/or law enforcement interact with on their computing devices (i.e., laptop or desktop computers). Administrator portal 700 allows administrative users to manage parking system 100. Administrator portal 700 is comprised of administrative UI modules 710, which includes administrative account login UI 711, administrative lot capacity UI 712, administrative lot/spot map UI 713, administrative spot closure input UI 714, administrative lot closure input UI 715, administrative alert input UI 716, administrative alert management UI 717, administrative electronic ticket management UI 718, vehicle sensor unit assignment UI 719, administrative user account management UI 720, and historical report UI 721.

Administrative account login UI 711 allows administrative users to use their existing organizational email account to log into administrator portal 700. Administrative lot capacity UI 712 displays a map of the campus to be managed by the administrative user, with annotations over each of the campus' parking lots. Each annotation displays the lot identifier and an occupancy percentage, and the annotation can be selected for a more detailed view of the status of parking spots reported in real time. Administrative lot/spot map UI 713 displays a map view of a selected parking lot, with map annotations displaying the status of every parking spot in that parking lot. The annotations may include customized symbols and colors to represent parking spots that are available, occupied, or closed, and to indicate whether the spot is a designated handicap spot. The annotations can also identify the parking user associated with the vehicle occupying a parking spot. Administrative lot/spot map UI 713 also displays parking lot occupancy data (i.e., occupancy percentages and counts of open or occupied parking spots).

Administrative spot closure UI 714 displays a map view of a specific parking lot, chosen by the administrative user, that includes map annotations displaying the live status of the parking spots in the specified parking lot whereby the administrative user can select an individual spot and apply an “open” or “closed” status to the selected spot. The administrative user may also use a drag-enabled selection box to select groups of spots to apply the “open” or “closed” status simultaneously.

Administrative lot closure input UI 715 allows administrative users to schedule the broadcasting of system-wide or lot-specific alerts regarding lot closures. Administrative lot closure input UI 715 displays a checklist of all parking lots included in parking system 100 as well as a form to create a system-wide, or lot-specific closure alert for dissemination. The administrative user may select one, or multiple, parking lots from the checklist, and fill the alert form with an alert title, description, effective start date, effective end date, and details regarding the closure.

Administrative alert input UI 716 allows administrative users to immediately broadcast or schedule alerts system-wide or to lot-specific parking users. Administrative alert input UI 716 displays a checklist of all parking lots included in parking system 100 as well as a form to create a system-wide, or lot-specific alert for dissemination. The administrative user may select one, or multiple, parking lots from the checklist, and fill in the alert form with an alert title, description, effective start date, effective end date, and details regarding the alert.

Administrative alert management UI 717 displays all current and future alerts, allowing the administrative user to select an alert for edification of any alert information. Administrative electronic ticket management UI 718 displays all electronically issued parking tickets, including the photos saved within database 201 in relation to the issued parking tickets, as well as time, location, vehicle, parking user, and payment status information. Vehicle sensor unit assignment UI 719 displays all of the issued vehicle sensor units 300 in parking system 100. Administrative users can assign new vehicle sensor units 300 to parking user accounts, and void old or broken vehicle sensor units 300, thereby removing interactions of those voided vehicle sensor units 300 with parking system 100. Administrative user account management UI 720 displays a search function for administrative users whereby administrative users may search by name, email account, or license plate information, and update any account information that would be verified by a corresponding police department (i.e., handicap status of vehicles equipped with a vehicle sensor unit 300). Historical report UI 721 allows administrative users to generate a report of historical data of parking lot occupancy percentages for parking lots over selected intervals of times.

Administrator portal 700 also includes administrative UI controller modules 731 which are background modules that handle the format and display of data processed by intelligence module 200 for display on administrative UI modules 710. The sending and receiving of live data between intelligence module 200 and administrative UI controller modules 731 is facilitated by administrative GraphQL, REST API, and MQTT communication modules 732.

FIG. 7B depicts an exemplary embodiment of administrative spot closure UI 714, depicting a map 755 of the status of all spots of the parking lot specified by the administrative user. Administrative spot closure UI 714 permits the administrative user to select specific spots to apply an “open” or “closed” status to those spots. Administrative spot closure UI 714 displays lot details 750 (i.e., lot number, lot name, lot type, number of spots, number of occupied spots, number of open spots, occupancy rate), and administrative lot legend 751 to define the annotations used to indicate the status of the spots (e.g., occupied, open, open handicap spot, occupied handicap spot, closed). Administrative users may also select specific spots in map 755 to view details regarding the selected spots at detail box 752. Upon selection of spots in map 755, selected spot information box 753 displays the row and spot number of the selected spots, as well as whether those spots are “open” or “closed.” Administrative user may opt to close the selected spots via the “Close Selected Spots” CTA button 754. Other embodiments may also include a UI that displays a list view, rather than a map view, of currently open lots and/or closed lots, which administrative users may select to open or close, as well as send a message to all administrative users to communicate a message title, message description, and the dates the opening/closure is to remain effective.

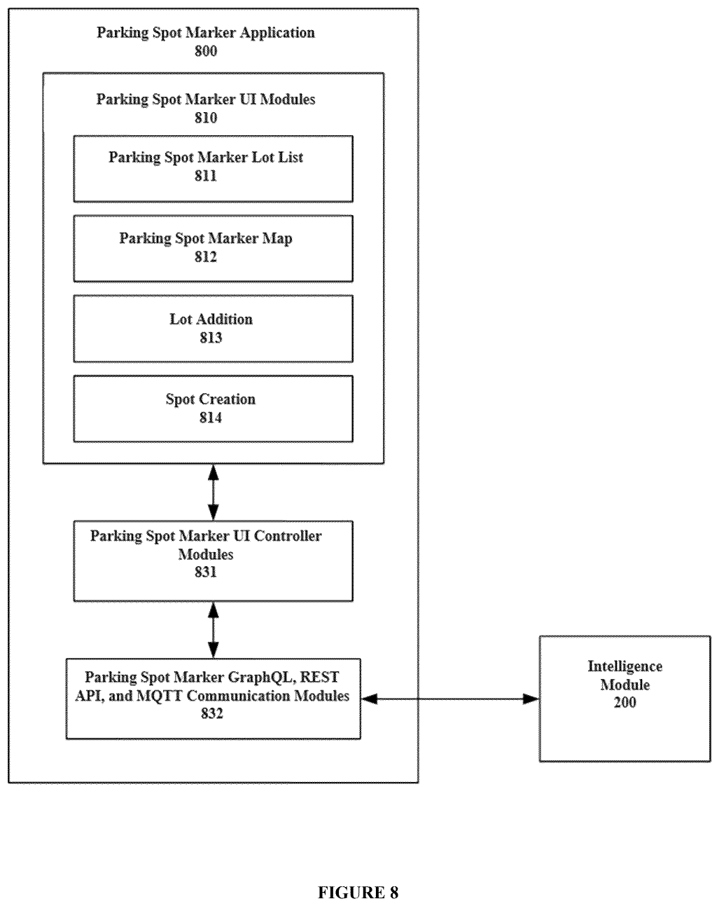

FIG. 8 shows an exemplary embodiment of the parking spot marker application 800. While this specific embodiment addresses a mobile application, the invention is not so limited and may be embodied via a website application as well. Parking spot marker application 800 is the front-end UI service that administrative users interact with on their mobile device via the parking spot marker UI modules 810 to inventory every parking spot on the geofenced areas of parking system 100. Parking spot marker application 800 displays system data and functionalities to the administrative user via the parking spot marker UI modules 810 and includes background modules that interact with intelligence module 200 to format the processed data into readable text and images.

More specifically, parking spot marker UI modules 810 includes lot list UI 811, parking spot marker map UI 812, lot addition UI 813, and spot creation UI 814.

Lot list UI 811 displays a list of existing parking lots managed by parking system 100 that has already been created in database 201. Parking lots listed in lot list UI 811 are selectable for edification by administrative users. Parking spot marker map UI 812 displays a map view with annotations for every spot that has been inventoried within a specific parking lot of parking system 100. Lot addition UI 813 allows administrative users to create a new parking lot to be managed by parking system 100. Spot creation UI 814 allows administrative users to select the precise location of a parking spot on a map, assign spot information (i.e., its location within the parking lot, or whether the spot is designated for handicapped drivers), and add that new spot to the chosen parking lot for management by parking system 100.

Parking spot marker application 800 includes parking spot marker UI controller modules 831, which are background modules that format and display, in real time, data from intelligence module 200 for viewing by administrative users via parking spot marker application 800. The sending and receiving of live data between intelligence module 200 and marker UI controller modules 831 is facilitated by marker GraphQL, REST API, and MQTT communication modules 832, which are background modules that interact with the GraphQL 212, REST API 211, and MQTT 213 of intelligence module 200, respectively, for the sending and receiving of live data.

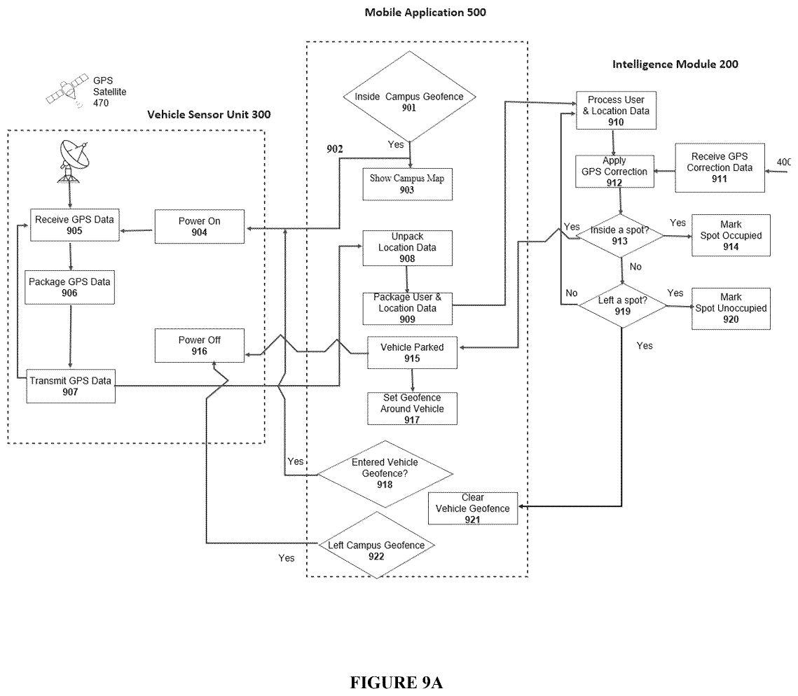

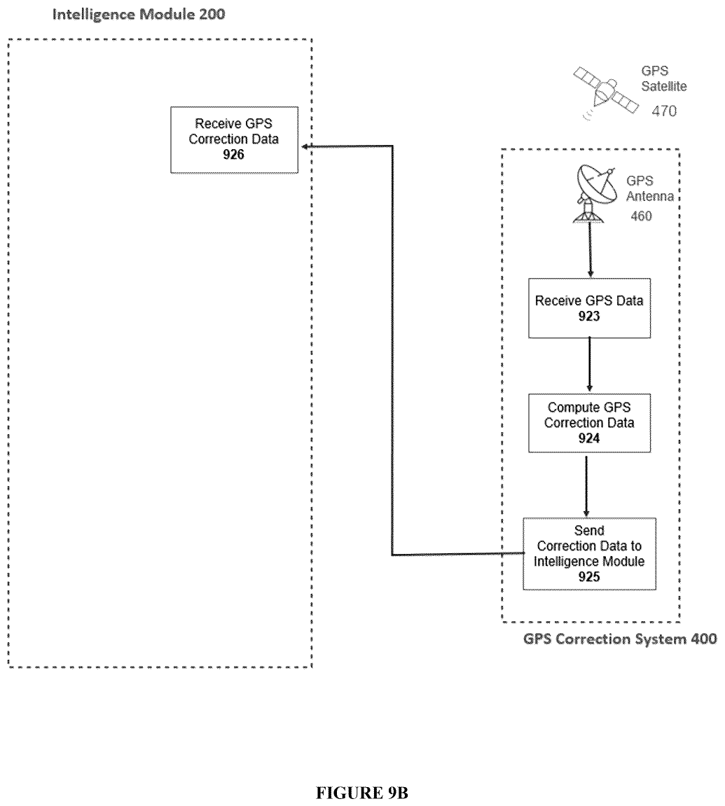

FIG. 9A depicts an exemplary flow showing communications and interactions between the vehicle sensor unit 300, mobile application 500, and intelligence module 200. At 901, mobile application 500 is notified that the parking user's device bearing the mobile application 500 is within a preset campus geofence. At 902, mobile application 500 notifies the vehicle sensor unit 300 to power on via Bluetooth module 304. At 903, mobile application 500 presents lot capacity UI 513, showing a summary view of the parking user's preferred lot/s and of all commuter parking lots and all residential parking lots so that parking users may quickly view occupancy data of all commuter and/or residential parking lots available to the parking user. At 904, vehicle sensor unit 300 powers on. At 905, vehicle sensor unit 300 starts receiving GPS location data via GPS receiver module 303. At 906, vehicle sensor unit 300 packages data via CPU 301 for efficient Bluetooth transmission to mobile application 500 via Bluetooth module 304. At 907, vehicle sensor unit 300 transmits the GPS location data to mobile application 500 via Bluetooth module 304. At 908, mobile application 500 receives the GPS location data from vehicle sensor unit 300 via Bluetooth communication module 522 and processes the GPS location data from vehicle sensor unit 300. At 909, mobile application 500 processes and sends the GPS location data and parking user data to intelligence module 200 via GraphQL, REST API, and MQTT communication modules 532. At 910, intelligence module 200 processes the incoming GPS location data and parking user data from mobile application 500. At 911, intelligence module 200 receives incoming streaming correction data from GPS correction system 400 and applies the correction data to the GPS location data accumulated by vehicle sensor unit 300. At 913, intelligence module 200 applies algorithms to detect if vehicle sensor unit 300 is inside a specific geofenced area by computing the distance of the vehicle sensor unit 300 from the center of the geofenced area. At 914, if intelligence module 200 determines that the vehicle sensor unit 300 is inside a parking spot, then intelligence module 200 records the parking spot as “occupied,” and sends a message to mobile application 500 to record the spot as the vehicle's parked location. Also at 914, intelligence module 200 notifies all parking users of mobile application 500 within the parking lot containing the newly parked vehicle to update the status of the newly occupied parking spot to “occupied” for display in each parking user's mobile application 500. At 915, mobile application 500 records the new status of the parking spot as “vehicle parked” by vehicle sensor unit 300 and sends an instruction to vehicle sensor unit 300 to power down via Bluetooth communication module 522. At 916, vehicle sensor unit 300 powers down to save battery. At 917, mobile application 500 sets a geofence around the parked vehicle via geofence manager module 521. At 918, mobile application 500 detects, via geofence manager module 521, when the parking user's mobile device enters a geofenced area surrounding the vehicle (i.e., after the parking user leaves the vehicle and returns at a later time to move out of the parked spot) and sends a message, via Bluetooth communication module 522, to vehicle sensor unit to power on to repeat steps 904 to 909. At 919, the parking user's vehicle that's equipped with vehicle sensor unit 300 moves out of a parking spot and at 920, intelligence module 200 marks the parking spot as unoccupied and sends a message to mobile application 500. Also at 919, intelligence module 200 notifies all parking users of mobile application 500 within the parking lot containing the newly vacant parking spot to update the status of the newly vacant parking spot to “unoccupied” or “available” for display in each parking user's mobile application 500.

At 921, mobile application 500 removes the geofence around the parked vehicle that's equipped with vehicle sensor unit 300 via geofence manager module 521. At 922, when the vehicle sensor unit 300—equipped vehicle leaves the preset geofenced campus, mobile application 500 sends a message to vehicle sensor unit 300 to power down via Bluetooth communication module 304.

FIG. 9B shows a flow chart showing communication between intelligence module 200 and GPS correction system 400. At 923, GPS location data of calibrated fixed positions from GPS satellites 470 is received by GPS station 450 via GPS antenna 460. At 924, GPS station 450 computes GPS correction data via its station CPU 451 using the calibrated fixed position data from GPS antenna 460 and live location data from vehicle sensor unit 300 and mobile application 500, received via network interface 454. At 925, GPS station 450 streams the GPS correction data to intelligence module 200 via network interface 454. At 926, intelligence module 200 applies the GPS correction data to all incoming GPS location data to compute the precise location of each vehicle sensor unit 300.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A parking system, the system comprising:
a cloud-based software system adapted to process and manage user data and GPS location data;
a parking user interface adapted to show parking users information relating to parking occupancy and allow the parking users to modify and input personal, vehicular, and optionally payment information, wherein the parking user interface is any suitable device, software, interactive modality or other mechanism adapted to display and exchange the user data and the GPS location data with the cloud-based software system;
a vehicle sensor unit adapted to receive and transmit the GPS location data;
a GPS correction system; and
an administrative user interface, wherein the administrative user interface is adapted to show administrative users information relating to parking occupancy.

2. The parking system as recited in claim 1, wherein the cloud-based software system is adapted to predict parking lot occupancy and recommend specific parking spots to the parking users based on accumulated historical occupancy data.

3. The parking system as recited in claim 1, the vehicle sensor unit comprising:
a central processing unit;
a memory;
a GPS module, wherein the GPS module gathers a geolocation of the vehicle sensor unit;
a Bluetooth module, wherein the Bluetooth module facilitates an exchange of data between the vehicle sensor unit and the parking user interface; and
a battery.

4. The parking system as recited in claim 1, the GPS correction system comprising:
a station memory;
multiple satellites;
a station GPS module, wherein the station GPS module gathers fixed location data from the multiple satellites via the GPS antenna;
a GPS antenna distribution unit;
a station central processing unit adapted to receive location data from the GPS receiver unit, compute differential corrections to the location data, and stream corrected location data to the cloud-based software system;
a station power unit, wherein the station power unit manages power to the GPS station and the GPS antenna;
a GPS antenna; and
a network interface that streams correction data from the cloud-based software system via an ethernet module.

5. The parking system as recited in claim 1, wherein the administrative user interface is adapted to show the administrative users information relating to parking occupancy and management, and wherein the administrative user interface allows the administrative users to modify the parking occupancy information and circulate parking-related announcements to the parking user interface.

6. The parking system as recited in claim 1, further comprising a parking spot marker user interface, wherein the parking spot marker user interface is adapted to allow the administrative users to add, remove, or otherwise modify the status of every parking spot of the parking management system.

7. The parking system as recited in claim 1, further comprising a patrol user interface, wherein the patrol user interface is adapted to show patrol users information relating to parking occupancy, management, payment, and enforcement and allow the patrol users to modify parking occupancy information, circulate parking-related announcements to the users, and issue electronic violation citations to the users.

8. The parking system as recited in claim 7, the patrol user interface further comprising a vehicle image detection model.

9. A method for managing parking lots, the method comprising the following steps:
establishing a geofence of at least one parking lot;
gathering fixed GPS location data of the at least one parking lot and at least one parking spot;
acquiring live GPS location data of a vehicle sensor unit within the geofence of the at least one parking lot;
correcting the live GPS location data of the vehicle sensor unit to obtain adjusted GPS location data;
recording the adjusted GPS location data; and
establishing a geofence around the vehicle sensor unit;
displaying occupancy data of the at least one parking lot on at least one user interface.

10. The method for managing parking lots as recited in claim 9, wherein the fixed GPS location data of the at least one parking lot and the at least one parking spot are stored in a cloud-based software system.

11. The method for managing parking lots as recited in claim 10, wherein the cloud-based software system is adapted to predict parking lot occupancy and recommend specific parking spots to parking users based on accumulated historical occupancy data.

12. The method for managing parking lots as recited in claim 9, wherein the vehicle sensor unit is a hardware device comprising:
a central processing unit;
a memory;
a GPS module, wherein the GPS module gathers a geolocation of the vehicle sensor unit;
a Bluetooth module, wherein the device Bluetooth module facilitates an exchange of data between the vehicle sensor unit and the parking user interface; and
a battery.

13. The method for managing parking lots as recited in claim 9, wherein the fixed GPS location data is acquired by a GPS correction system, the GPS correction system comprising:
a station memory;
a GPS antenna;
multiple satellites;
a station GPS module, wherein the station GPS module gathers fixed location data from the multiple satellites via the GPS antenna;
a GPS antenna distribution unit;
a station central processing unit adapted to receive location data from the GPS receiver unit, compute differential corrections to the location data, and stream corrected location data to the cloud-based software system;
a power unit; wherein the power unit manages power to the GPS station and the GPS antenna; and
a network interface that streams correction data from the cloud-based software system via an ethernet module.

14. The method for managing parking lots as recited in claim 9, wherein the adjusted GPS location data is processed by and recorded in a cloud-based software system adapted to process and manage user data and the GPS location data.

15. The method for managing parking lots as recited in claim 9, wherein the at least one user interface includes:
a parking user interface, wherein the parking user interface is adapted to show the parking users information relating to parking occupancy and allow the parking users to modify and input personal, vehicular, and optionally payment information, wherein the parking user interface is any suitable device, software, interactive modality or other mechanism adapted to display and exchange the user data and the GPS location data with the cloud-based software system; and
an administrative user interface, the administrative user interface is adapted to show administrative users information relating to parking occupancy.

16. The method for managing parking lots as recited in claim 15, wherein the administrative users manage information relating to the parking occupancy by allowing the administrative users to modify the parking occupancy information and circulate parking-related announcements to the parking user interface.

17. The method for managing parking lots as recited in claim 15, wherein the at least one user interface also includes a patrol user interface, wherein the patrol user interface is adapted to allow patrol users to patrol parking lots, issue digital parking violation citations, and view and manage information relating to parking occupancy and safety via the patrol user interface, and wherein the parking patrol user interface is adapted to allow the patrol users to modify the parking occupancy information and circulate parking-related announcements to the parking user interface.

18. The method for managing parking lots as recited in claim 15, wherein the at least one user interface also includes a parking spot marker user interface, wherein the parking spot marker user interface is adapted to allow the administrative users to add, remove, or otherwise modify the status of every parking spot of the parking management system.
